(19) United States
(12) Patent Application Publication
(10) Pub. No.: US 2018/0233776 A1
(43) Pub. Date: Aug. 16, 2018

(54) SOLID ELECTROLYTE MATERIAL AND METHOD FOR PREPARING THE SAME, SOLID ELECTROLYTE AND BATTERY

(71) Applicant: BYD COMPANY LIMITED, Shenzhen (CN)

(72) Inventors: JING XIE, SHENZHEN (CN); YONGJUN MA, SHENZHEN (CN); GUANGUI YI, SHENZHEN (CN); ZIZHU GUO, SHENZHEN (CN)

(21) Appl. No.: 15/956,371

(22) Filed: Apr. 18, 2018

Related U.S. Application Data
(63) Continuation of application No. PCT/CN2016/102593, filed on Oct. 19, 2016.

(30) Foreign Application Priority Data
Oct. 23, 2015 (CN) 201510695407.5

(51) Int. Cl. H01M 10/0562; H01M 10/058; H01M 10/052; H01M 4/131

(52) U.S. Cl. CPC H01M 10/0562; H01M 10/058; H01M 2004/027; H01M 4/131; H01M 10/052

(57) ABSTRACT

A solid electrolyte material and a method for preparing the same, a solid electrolyte and a battery are provided. The solid electrolyte material includes: at least one of crystalline inorganic solid electrolyte having a formula of Li_{10±1}AB₂X₁₂ (I); and at least one of amorphous inorganic solid electrolyte having a formula of yLi₂X′-(100-y)P₂X′₅ (II).

### CROSS-REFERENCE TO RELATED APPLICATION

This application is a continuation application of International Patent Application No. PCT/CN2016/102593, filed on Oct. 19, 2016, which claims priority to and benefits of Chinese Patent Application No. 201510695407.5, filed with the State Intellectual Property Office of P. R. China on Oct. 23, 2015. The entire content of the above-referenced applications is incorporated herein by reference.

### FIELD

The present disclosure generally relates to a solid electrolyte material and a method for preparing the same, a solid electrolyte and a battery.

### BACKGROUND

Currently, there are three kinds of inorganic solid electrolytes according to crystal structure thereof, which are crystalline inorganic solid electrolyte, amorphous inorganic solid electrolyte, and glass ceramic inorganic solid electrolyte. Moreover, the crystalline inorganic solid electrolyte only consists of one component. The crystalline inorganic solid electrolyte is usually prepared by a solid phase sintering method. For example, Li₁₀GeP₂S₁₂ may have an ionic conductivity of 12 mS/cm. The amorphous inorganic solid electrolyte may be prepared by a ball-milling method or a high temperature melting-quenching method. For example, 75Li₂S.25P₂S₅ may have an ionic conductivity of 3.4×10⁻⁴ S/cm. The glass ceramic inorganic solid electrolyte has a structure between crystalline state and amorphous state, and it is usually prepared by crystallizing the amorphous inorganic solid electrolyte, such as 75Li₂S.25P₂S₅, which has an ionic conductivity of 3.2×10⁻³ S/cm.

There are some drawbacks of these three kinds of inorganic solid electrolytes: the crystalline inorganic solid electrolyte, which has a high ionic conductivity, a high valence state element, such as Si, Ge, and Sn, may be easily reduced by the negative electrode when they are matched with a lithium metal negative electrode, then a local activity of the electrolyte may be lost; the amorphous inorganic solid electrolyte, such as yLi₂X′-(100-y)P₂X′₅ (X′═O/S/Se) (65≤y≤85), has a relative low ionic conductivity, generally less than 10⁻³ S·cm⁻¹; for the glass ceramic inorganic solid electrolyte, a crystallization rate of a crystalline component in the glass ceramic inorganic solid electrolyte is critical, and an over-high crystallization rate or an over-low crystallization rate may cause a low ionic conductivity of the glass ceramic inorganic solid electrolyte, thus making it difficult to prepare the glass ceramic inorganic solid electrolyte.

### SUMMARY

The present disclosure seeks to provide a solid electrolyte material having a good ionic conductivity. The solid electrolyte material may be simply prepared, and cannot be easily reduced by a metal negative electrode. The present disclosure also provides a method for preparing the solid electrolyte material, a solid electrolyte and a battery having a good charge-discharge performance and a good cycle performance.

The solid electrolyte material according to the present disclosure includes at least one of crystalline inorganic solid electrolytes having a formula of Li_{10±1}AB₂X₁₂ (I); and at least one of amorphous inorganic solid electrolytes having a formula of yLi₂X′-(100-y)P₂X′₅ (II); in which A is selected from Si, Ge, Sn, B or Al, and B is selected from P or As; X and X′ are the same or different, and are each independently selected from O, S or Se; and y is an integer in a range of 65 to 85.

The present disclosure also provides a method for preparing a solid electrolyte material mentioned above. The method includes: mixing at least two components (A) and (B), and calcining to obtain the crystalline inorganic solid electrolyte; and mixing the crystalline inorganic solid electrolyte and a component (C) to obtain the solid electrolyte material.

The present disclosure also provides a solid electrolyte, which includes a solid electrolyte material made by the method mentioned above.

The present disclosure also provides a battery, which includes a positive electrode, an electrolyte, and a negative electrode, in which the electrolyte includes the solid electrolyte mentioned above.

The solid electrolyte material according to the present disclosure may be prepared simply, may have a good ionic conductivity, and the solid electrolyte material will not be reduced easily by a metal negative electrode and may have a good stability. And the battery according to the present disclosure may have a good charge-discharge performance and a good cycle performance.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a SEM image of a solid electrolyte material obtained in Embodiment 1.

FIG. 2 is a XRD pattern of a crystalline inorganic solid electrolyte obtained in Embodiment 1.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure.

The present disclosure provides a solid electrolyte material, which includes at least one of crystalline inorganic solid electrolytes having a formula of Li_{10±1}AB₂X₁₂ (I); and at least one of amorphous inorganic solid electrolytes having a formula of yLi₂X′-(100-y)P₂X′₅ (II); in which A is selected from Si, Ge, Sn, B or Al, and B is selected from P or As; X and X′ are the same or different, and are each independently selected from O, S or Se; and y is an integer in a range of 65 to 85.

In some embodiments of the present disclosure, the crystalline inorganic solid electrolyte is at least one selected from a group of Li₁₀SnP₂S₁₂, Li₁₀GeP₂S₁₂, Li₁₀SiP₂S₁₂, Li₁₁AlP₂S₁₂, Li₁₀SnP₂Se₁₂, Li₁₀GeP₂Se₁₂ and Li₁₀SiP₂Se₁₂.

It should be noted that, the crystalline inorganic solid electrolyte may be commercially obtained, and may also be made by a common method in the art. For example, the crystalline inorganic solid electrolyte may be prepared via a process described below.

In some embodiments of the present disclosure, the amorphous inorganic solid electrolyte is at least one selected from a group of 70Li₂X′-30P₂X′₅, 75Li₂X′-25P₂X′₅ and 80Li₂X′-20P₂X′₅. For example, the amorphous inorganic solid electrolyte is at least one selected from a group of 70Li₂O-30P₂O₅, 75Li₂O-25P₂O₅, 80Li₂O-20P₂O₅, 70Li₂S-30P₂S₅, 75Li₂S-25P₂S₅, 80Li₂S-20P₂S₅, 70Li₂Se-30P₂Se₅, 75Li₂Se-25P₂Se₅ and 80Li₂Se-20P₂Se₅.

It should be noted that, the amorphous inorganic solid electrolyte can be made by a common method in the art. For example, the amorphous inorganic solid electrolyte can be prepared via a process described below.

According to the present disclosure, the solid electrolyte includes a crystal inorganic solid electrolyte and an amorphous inorganic solid electrolyte. The problem that crystal inorganic solid electrolyte may be reduced by metal negative electrode, may be avoided or relieved. In addition, the battery using the solid electrolyte according to the present disclosure may have a good charge and discharge performance and a good cycle performance. In order to further improve the effect, in some embodiments, at least part of a surface of the crystalline inorganic solid electrolyte is coated by the amorphous inorganic solid electrolyte. That is, amorphous inorganic solid electrolyte is in-situ grown on at least part of surface of the crystalline inorganic solid electrolyte, and then at least part of surface of the crystalline inorganic solid electrolyte is coated by the amorphous inorganic solid electrolyte. Therefore, by using the solid electrolyte material as a solid electrolyte, the solid electrolyte obtained may have a good ionic conducting property at both a normal temperature and a high temperature. And also, the lithium ion battery having the solid electrolyte may have a good charge and discharge performance and a good cycle performance because when the surface or part of the surface of the crystalline inorganic solid electrolyte is coated by the amorphous inorganic solid electrolyte, the crystalline inorganic solid electrolyte may be partially or wholly isolated from directly contacting with the lithium metal by the amorphous inorganic solid electrolyte, and then the crystal inorganic solid electrolyte may be avoided or relieved from being reduced by metal negative electrode, thus to improve a stability and a cycle performance of the battery. It should be noted that “at least part of the crystalline inorganic solid electrolyte is coated by the amorphous inorganic solid electrolyte” can be that the whole surface of the crystalline inorganic solid electrolyte is coated by the amorphous inorganic solid electrolyte, or part of the surface of the crystalline inorganic solid electrolyte is coated by the amorphous inorganic solid electrolyte (for example, half of the surface of the crystalline inorganic solid electrolyte, or a small part of the surface of the crystalline inorganic solid electrolyte, or just point shapes or spots distributed on surface of the crystalline inorganic solid electrolyte), or some particles of the crystalline inorganic solid electrolyte are coated with the amorphous inorganic solid electrolyte on their whole surfaces and the other particles of the crystalline inorganic solid electrolyte are coated with the amorphous inorganic solid electrolyte on parts of their surfaces.

The solid electrolyte material according to the present disclosure may have a good ionic conductivity. In order to further improve the ionic conductivity of the solid electrolyte material, in some embodiments, a weight ratio of the crystalline inorganic solid electrolyte to the amorphous inorganic solid electrolyte is about 10:1 to 0.1:1. For example, a weight ratio of the crystalline inorganic solid electrolyte to the amorphous inorganic solid electrolyte is about 8:1 to 9:1. With the range of weight ratio stated above, an appropriate amount of the crystalline inorganic solid electrolyte can be coated, so as to obtain a most appropriate effect that the obtained solid electrolyte may be prevented from being reduced by metal negative electrode and a most improved ionic conductivity. In some embodiments, based on total weight of the solid electrolyte material, the crystalline inorganic solid electrolyte and the amorphous inorganic solid electrolyte have a total amount of greater than 80%, alternatively, greater than 90%, for example, 95% to 100%.

The solid electrolyte material according to the present disclosure may have a good ionic conductivity. For example, the solid electrolyte material has an ionic conductivity of about 1×10⁻⁴ to 1×10⁻²S/cm at 25 Celsius degrees, and an ionic conductivity of about 1×10⁻³ to 0.1 S/cm at 100 Celsius degrees. In some embodiments, the solid electrolyte material has an ionic conductivity of about 1×10⁻³ to 9.9×10⁻³S/cm at 25 Celsius degrees, and an ionic conductivity of about 7×10⁻³ to 9.9×10⁻²S/cm at 100 Celsius degrees.

The present disclosure also provides a method for preparing a solid electrolyte material mentioned above. According to one embodiment, the method includes: mixing and calcining at least two components (A) and (B) to obtain the crystalline inorganic solid electrolyte; and mixing the crystalline inorganic solid electrolyte and a component (C) to obtain the solid electrolyte material.

It should be noted that, there are no particular limitation for the two components (A) and (B), as long as the two components (A) and (B) can be used for preparing the crystalline inorganic solid electrolyte. The crystalline inorganic solid electrolyte obtained has a formula of Li_{10±}AB₂X₁₂, in which A, B, and X have the same meanings as stated above and the crystalline inorganic solid electrolyte shown by Li_{10±1}AB₂X₁₂ may also be referred to the above description, which are not described herein.

In one embodiment, component (A) may include Li₂S and SnS₂ and component (B) may include P₂S₅; in another embodiment, component (A) may include Li₂O and GeO₂ and component (B) may include P₂O₅; in another embodiment, component (A) may include Li₂O, SnO₂ and component (B) may include P₂O₅; in a further embodiment, component (A) may include Li₂S and SiS₂ and component (B) may include P₂S₅; in another further embodiment, component (A) may include Li₂S and GeS₂ and component (B) may include P₂S₅; in another further embodiment, component (A) may include Li₂S and Al₂S₃ and component (B) may include P₂S₅; in another further embodiment, component (A) may include Li₂Se and GeSe₂ and component (B) may include P₂Se₅; or in another further embodiment, component (A) may include Li₂Se and SnSe₂ and component (B) may include P₂Se₅.

It should be noted that there is no particular limitation for the amount of the at least two components (A) and (B). For example, a molar ratio of Li₂S and SnS₂ to P₂S₅ is about (5.5 to 5):(0.5 to 1):1; a molar ratio of Li₂O and GeO₂ to P₂O₅ is about (5.5 to 5):(0.5 to 1):1; a molar ratio of Li₂O and SnO₂ to P₂O₅ is about (5.5 to 5):(0.5 to 1):1; a molar ratio of Li₂O and SiO₂ to P₂O₅ is about (5.5 to 5):(0.5 to 1):1; a molar ratio of Li₂S and SiS₂ to P₂S₅ is about (5.5 to 5):(0.5 to 1):1; a molar ratio of Li₂S and GeS₂ to P₂S₅ is about (5.5 to 5):(0.5 to 1):1; a molar ratio of Li₂S and Al₂S₃ to P₂S₅ is about (5.5 to 5):(0.5 to 1):1; a molar ratio of Li₂Se and GeSe₂ to P₂Se₅ is about (5.5 to 5):(0.5 to 1):1; and a molar ratio of Li₂Se and SnSe₂ to P₂Se₅ is about (5.5 to 5):(0.5 to 1):1.

In the present disclosure, the at least two components (A) and (B) can be mixed via a common mixing method in the art, as long as the at least two components (A) and (B) can be mixed uniformly. For example, the at least two components (A) and (B) are mixed via a high energy ball-milling equipment at a rotation speed of about 50 rpm to about 500 rpm for about 0.1 hours to about 6 hours.

In the present disclosure, after the at least two components (A) and (B) are mixed, a mixture obtained can be tableted to form a tablet material, and then the tablet material is calcined. For example, the mixture obtained can be tableted at a pressure of about 10 MPa to about 20 MPa.

It should be noted that there are no particular limitations for the calcining step, as long as the crystalline inorganic solid electrolyte can be obtained after calcining the at least two components (A) and (B). For example, the calcining step can be carried out at a temperature of about 350 Celsius degrees to about 800 Celsius degrees for about 6 hours to about 100 hours (such as about 6 hours to about 10 hours).

It should be noted that there are no particular limitation for the amount of the component (C), as long as the component (C) can be used to prepare the amorphous inorganic solid electrolyte. The amorphous inorganic solid electrolyte obtained has a formula of yLi₂X′-(100-y)P₂X′₅, in which X′ and y have the same meanings as stated above and the amorphous inorganic solid electrolyte shown by yLi₂X′-(100-y)P₂X′₅ is also referred to the above description, which are not described herein.

In some embodiments of the present disclosure, when the amorphous inorganic solid electrolyte has a formula of yLi₂X′-(100-y)P₂X′₅, the component (C) includes Li₂S and P₂S₅, and a molar ratio of Li₂S to P₂S₅is about 2:1 to 4:1.

In embodiments of the present disclosure, after mixing the crystalline inorganic solid electrolyte and a component (C), an amorphous inorganic solid electrolyte is in-situ grown on surface of the crystalline inorganic solid electrolyte, and then at least part of the surface of the crystalline inorganic solid electrolyte is coated by the amorphous inorganic solid electrolyte so as to obtain the solid electrolyte material. That is, there are no particular limitations for the mixing process, as long as that after mixing the crystalline inorganic solid electrolyte and a component (C), at least part of surface of the crystalline inorganic solid electrolyte is coated by the amorphous inorganic solid electrolyte. For example, the crystalline inorganic solid electrolyte and a component (C) can be mixed by a ball-milling method or a high temperature melting-quenching method. In some embodiments, the crystalline inorganic solid electrolyte and a component (C) are mixed by a high energy ball-milling method at a rotation speed of about 100 rpm to about 500 rpm for about 4 hours to about 200 hours (for example, 8 hours to 24 hours).

The present disclosure also provides a solid electrolyte, which includes the solid electrolyte material mentioned above.

In some embodiments, based on total weight of the solid electrolyte, the solid electrolyte material has an amount of about 50 wt % to about 100 wt %. That is, the whole solid electrolyte or part of the solid electrolyte can be the solid electrolyte material of the present disclosure. When part of the solid electrolyte is the solid electrolyte material, the solid electrolyte further includes an additive agent that commonly used in a solid electrolyte. For example, the additive agent is at least one selected from a group of styrene-butadiene rubber, styrene-ethylene-butadiene rubber, polyvinylidene fluoride, polytetrafluoroethylene, poly(ethylene-oxide) and polysiloxane.

The present disclosure also provides a battery, which includes a positive electrode, an electrolyte, and a negative electrode, in which the electrolyte includes the solid electrolyte mentioned above.

It should be noted that there are no particular limitations for the positive electrode and the negative electrode. They can be positive electrode and the negative electrode commonly used in the art. The positive electrode includes a positive current collector and a positive electrode material layer disposed on surface of the positive current collector. The positive electrode material layer includes a positive electrode active substance, a conductive agent, an adhesive and a solid electrolyte. Alternatively, the positive electrode includes the solid electrolyte according to the present disclosure. In some embodiments, in the positive electrode material layer, a weight ratio of the positive electrode active material to the solid electrolyte is about 1:1 to 9:1, for example, 3:1 to 9:1. Specifically, the positive electrode active material can be any commonly used positive electrode active material in the art. For example, the positive electrode active material includes at least one of LiNi_{10.5}Mn_{1.5}O₄, LiMn₂O₄, LiCoPO₄, LiNiPO₄, Li₃V₃(PO₄)₃. It should be noted that the conductive agent and the adhesive can be any commonly used conductive agent and adhesive in the art. Moreover, the negative electrode can be any commonly used negative electrode in the art, such as lithium metal or lithium-indium alloy.

It should be noted that there are no particular limitations for the preparing process of the battery, and it can be any common preparing process of solid lithium battery. Generally, after the positive electrode is prepared, solid electrolyte slurry is coated on surface of the positive electrode material layer, and lithium metal or lithium-indium alloy is used as a negative electrode to prepare the solid lithium battery. It should be noted that the specific preparing process is well known by those skilled in the art, therefore, detailed description is omitted herein.

The present disclosure will be further illustrated below in conjunction with some exemplary embodiments.

XRD (X-Ray Diffraction) test conditions: Japan Rigaku SmartLab X-ray diffractometer, tube voltage: 40 kV, tube current: 20 mA, Cu Ka ray, graphite monochromator, stride width: 0.02°, dwell time: 0.2 seconds.

The ionic conductivity is determined by an electrochemical impedance method, including steps of: 0.4 gram solid electrolyte is placed in a mould having a diameter of 13 millimeters; the solid electrolyte is clamped by two stainless steel sheets and compacted at a pressure of 10 MPa to form an electrolyte plate. Then the electrolyte plate is subjected to an isostatic pressing treatment at 370 MPa, subsequently the electrolyte plate is placed in a batter module to perform the electrochemical impedance test at a frequency of 1 MHz to 1 Hz, and amplitude of 50 mV.

### EMBODIMENT 1

This embodiment is used here to describe a solid electrolyte material and a method for preparing the same.

1) Li₂S, SnS₂ and P₂S₅ were ball-milled in a high-energy ball-milling equipment (Retsch Company, PM 400 high-energy ball-milling machine) under an argon atmosphere at a rotation speed of 100 rpm for 1 hour, thus obtaining uniformly mixed mixture powders. Li₂S, SnS₂ and P₂S₅ have a molar ratio of 5:1:1. The mixture powders were tableted at 10 MPa to form a tablet material, and then the tablet material was calcined under an argon atmosphere at a temperature of 600 Celsius degrees for 8 hours, thus obtaining a solid material. The solid material, which was testified by XRD test, is a crystalline inorganic solid electrolyte, i.e., crystal particles, having a chemical formula of Li₁₀SnP₂S₁₂, and the XRD pattern is shown in FIG. 2.

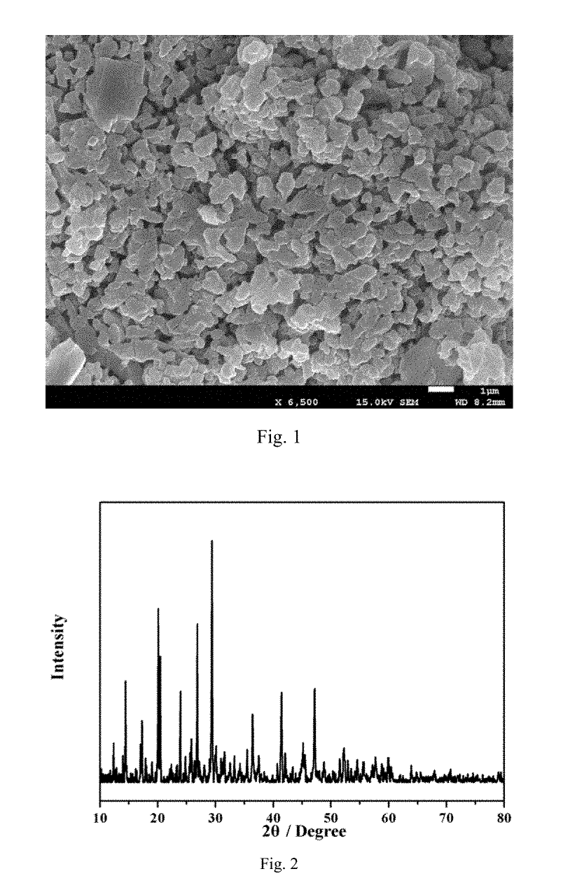

2) The Li₁₀SnP₂S₁₂ obtained and a mixture of Li₂S and P₂S₅ (a molar ratio of Li₂S to P₂S₅ is 75:25) were ball-milled in the high-energy ball-milling equipment under an argon atmosphere at a rotation speed of 370 rpm for 12 hours, thus obtaining a solid electrolyte material. A weight ratio of the Li₁₀SnP₂S₁₂ to the mixture of Li₂S and P₂S₅ is 4:1. Through transmission electron microscopy pattern and electron diffraction analysis method, it is testified that an amorphous inorganic solid electrolyte having a formula of 75Li₂S-25P₂S₅ is in-situ grown on surface of the crystal particle of Li₁₀SnP₂S₁₂. The SEM (Scanning Electron Microscopy) image is shown in FIG. 1.

The obtained solid electrolyte material was tableted and tested. The results show that the obtained solid electrolyte material has an ionic conductivity of about 1.42×10⁻³ S/cm at 25 Celsius degrees, and an ionic conductivity of about 7.09×10⁻³ S/cm at 100 Celsius degrees.

### EMBODIMENT 2

This embodiment is used here to describe a solid electrolyte material and a method for preparing the same.

A solid electrolyte material is prepared using the steps identical to those in embodiment 1, except for that: the molar ratio of Li₂S to P₂S₅ is 80:20, the weight ratio of the Li₁₀SnP₂S₁₂ to the mixture of Li₂S and P₂S₅ is 7:3. Through transmission electron microscopy pattern and electron diffraction analysis method, it is demostrated that an amorphous inorganic solid electrolyte having a formula of 80Li₂S-20P₂S₅ is in-situ grown on surface of the crystal particle of Li₁₀SnP₂S₁₂.

The obtained solid electrolyte material was tableted and tested. The results show that the obtained solid electrolyte material has an ionic conductivity of about 2.49×10⁻³ S/cm at 25 Celsius degrees, and an ionic conductivity of about 8.26×10⁻³ S/cm at 100 Celsius degrees.

### EMBODIMENT 3

This embodiment is used here to describe a solid electrolyte material and a method for preparing the same.

1) Li₂S, GeS₂ and P₂S₅ were ball-milled in a high-energy ball-milling equipment (Retsch Company, PM 400 high-energy ball-milling machine) under an argon atmosphere at a rotation speed of 120 rpm for 1 hour, thus obtaining uniformly mixed mixture powders. Li₂S, SnS₂ and P₂S₅ have a molar ratio of 5:1:1. The mixture powders were tableted at 10 MPa to form a tablet material, and then the tablet material was calcined under an argon atmosphere at a temperature of 600 Celsius degrees for 8 hours, thus obtaining a solid material. The solid material, which was testified by XRD test, is a crystalline inorganic solid electrolyte, i.e., crystal particles, having a chemical formula of Li₁₀GeP₂S₁₂.

2) The Li₁₀GeP₂S₁₂ obtained and a mixture of Li₂S and P₂S₅ (a molar ratio of Li₂S to P₂S₅ is 80:20) were ball-milled in the high-energy ball-milling equipment under an argon atmosphere at a rotation speed of 370 rpm for 24 hours, thus obtaining a solid electrolyte material. A weight ratio of the Li₁₀GeP₂S₁₂ to the mixture of Li₂S and P₂S₅ is 9:1. Through transmission electron microscopy pattern and electron diffraction analysis method, it is testified that an amorphous inorganic solid electrolyte having a formula of 80Li₂S-20P₂S₅ is in-situ grown on surface of the crystal particle of Li₁₀GeP₂S₁₂.

The obtained solid electrolyte material was tableted and tested. The results show that the obtained solid electrolyte material has an ionic conductivity of about 6.01×10⁻³ S/cm at 25 Celsius degrees, and an ionic conductivity of about 2.02×10⁻² S/cm at 100 Celsius degrees.

### EMBODIMENT 4

This embodiment is used here to describe a solid electrolyte material and a method for preparing the same.

The crystal particles of Li₁₀SnP₂S₁₂ were obtained according to Embodiment 1, and then Li₂S and P₂S₅ (a molar ratio of Li₂S to P₂S₅ is 75:25) were mixed and ball-milled in a high-energy ball-milling equipment under an argon atmosphere at a rotation speed of 370 rpm for 12 hours, thus obtaining 75Li₂S-25P₂S₅having a glassy state. Then the obtained Li₁₀SnP₂S₁₂ and the obtained 75Li₂S-25P₂S₅ (a weight ratio of Li₁₀SnP₂S₁₂ to 75Li₂S-25P₂S₅ is 4:1) were mixed to obtain a mixture, subsequently the mixture was tableted and tested. The results show that the obtained mixture has an ionic conductivity of about 7.81×10⁻⁴ S/cm at 25 Celsius degrees, and an ionic conductivity of about 2.62×10⁻³ S/cm at 100 Celsius degrees.

### EMBODIMENTS 5-8

This embodiment is used here to describe a battery of the present disclosure.

All solid lithium batteries S1-S4 are prepared under argon atmosphere, taking the solid electrolyte materials obtained in Embodiments 1-4 as an electrolyte respectively, taking metal Lithium as a negative electrode, and taking LiNi_{0.5}Mn_{1.5}O₄ as a positive electrode. The preparing process includes:

A positive electrode active material LiNi_{0.5}Mn_{1.5}O₄ of 700 grams, a solid electrolyte material of 230 grams obtained according to embodiments of the present disclosure, an adhesive SBR of 30 grams, an acetylene black of 20 grams, and a conductive agent HV of 20 grams were added in an anhydrous heptane solvent of 1500 grams to form a mixture, and then the mixture was stirred in a vacuum agitator to form stable and uniform positive slurry. The positive slurry was uniformly and intermittently coated on an aluminum foil (which has a width of 160 millimeters and a thickness of 16 millimeters), dried at 80 Celsius degrees, and then tableted via a roller, thus obtaining a positive electrode plate.

A solid electrolyte of 490 grams obtained according to embodiments of the present disclosure and an adhesive SBR of 10 grams were added in an anhydrous heptane solvent of 500 grams to form a mixture, and then the mixture was stirred in a vacuum agitator to form stable and uniform electrolyte slurry. The electrolyte slurry was uniformly and intermittently coated on the positive electrode plate obtained above, dried at 80 Celsius degrees, and then tableted via a roller, thus obtaining a composite electrode plate have an electrolyte coating layer and a positive electrode coating layer. A lithium foil was overlaid on surface of the obtained composite electrode plate, compressed at 240 MPa to compact the lithium foil and the composite electrode plate, and then assembled, thus obtaining an all solid lithium battery.

COMPARATIVE EMBODIMENT 1

A battery is prepared via the same process of Embodiment 5, except for that: the solid electrolyte is the crystalline inorganic solid electrolyte Li₁₀SnP₂S₁₂ obtained by Embodiment 1 (the solid electrolyte Li₁₀SnP₂S₁₂ has an ionic conductivity of about 2.16×10⁻³ S/cm at 25 Celsius degrees, and an ionic conductivity of about 9.2×10⁻³ S/cm at 100 Celsius degrees).

### COMPARATIVE EMBODIMENT 2

A battery is prepared via the same process of Embodiment 5, except for that: the solid electrolyte is the amorphous inorganic solid electrolyte 75Li₂S-25P₂S₅ obtained by Embodiment 1 (the solid electrolyte 75Li₂S-25P₂S₅ has an ionic conductivity of about 3.4×10⁻⁴ S/cm at 25 Celsius degrees, and an ionic conductivity of about 1.19×10⁻³ S/cm at 100 Celsius degrees)

### TEST EMBODIMENT

The batteries obtained in these Embodiments and Comparative Embodiments were placed on a LAND CT 2001C secondary battery performance testing device at 25±1 Celsius degrees to perform a charge and discharge cycle test at 0.01 C. The test includes steps of: resting for 10 minutes, charging to 5 V/0.05 C at a constant voltage, resting for 10 minutes, and discharging to 3.0 V at a constant current. Then one cycle was finished, and the cycle was repeated for 30 times. An initial charge capacity and an initial discharge capacity are recorded, and a discharging efficiency (%) is calculated according to an equation: Discharging efficiency (%)=Initial charge capacity/Initial discharge capacity×100%. A discharge capacity after 30 cycles is recorded, and a capacity retention ratio (%) is calculated according to an equation: Capacity retention ratio (%)=Discharge capacity after 30 cycles/Initial discharge capacity×100%. The test results are shown in

Table 1.

TABLE 1

| | Initial charge | Initial | Discharging | Capacity |
|---|---|---|---|---|
| | capacity | discharge | efficiency | retention |
| Battery | (mAh) | capacity (mAh) | (%) | ratio (%) |
| S1 | 1025 | 877 | 85.6% | 86.3% |
| S2 | 1038 | 895 | 86.2% | 89.5% |
| S3 | 1046 | 912 | 87.2% | 92.7% |
| S4 | 1013 | 832 | 82.1% | 82.2% |
| DS1 | 1125 | 799 | 71% | 53.6% |
| DS2 | 986 | 840 | 85.2% | 65.2% |

As shown in Table 1, the all solid lithium battery using the solid electrolyte according to the present disclosure has a high initial discharge capacity, a high discharging efficiency and a high capacity retention ratio.

Although the embodiments of the present disclosure have been shown and described, those of ordinary skill in the art can understand that multiple changes, modifications, replacements, and variations may be made to these embodiments without departing from the principle and purpose of the present disclosure.

It should be understood that technology features described in the above embodiments may be combined in any appropriate way if they are not conflicting with each other. In this case, possible combinations of these features will not be described again, thus avoiding the unnecessary obscuring of aspects of combinations.

In addition, various embodiments of the present disclosure may also be combined as long as being in the scope of the present disclosure, which should be regarded as contents of the present disclosure as well.

What is claimed is:

1. A solid electrolyte material, comprising:
at least one of crystalline inorganic solid electrolytes having a formula of Li_{10±1}AB₂X₁₂ (I), and
at least one of amorphous inorganic solid electrolytes having a formula of yLi₂X′-(100−y)P₂X′₅ (II);
wherein A is selected from Si, Ge, Sn, B or Al, and B is selected from P or As;
X and X′ are the same or different, and are each independently selected from O, S or Se; and
y is an integer in a range of 65 to 85.

2. The solid electrolyte material of claim 1, wherein the crystalline inorganic solid electrolyte is at least one selected from a group of Li₁₀SnP₂S₁₂, Li₁₀GeP₂S₁₂, Li₁₀SiP₂S₁₂, Li₁₁AlP₂S₁₂, Li₁₀SnP₂Se₁₂, Li₁₀GeP₂Se₁₂ and Li₁₀SiP₂Se₁₂, and the amorphous inorganic solid electrolyte is at least one selected from a group of 70Li₂X′-30P₂X′₅, 75Li₂X′-25P₂X′₅ and 80Li₂X′-20P₂X′₅.

3. The solid electrolyte material of claim 1, wherein at least part of a surface of the crystalline inorganic solid electrolyte is coated by the amorphous inorganic solid electrolyte.

4. The solid electrolyte material of claim 1, wherein a weight ratio of the crystalline inorganic solid electrolyte to the amorphous inorganic solid electrolyte is about 10:1 to 0.1:1.

5. The solid electrolyte material of claim 1, wherein a weight ratio of the crystalline inorganic solid electrolyte to the amorphous inorganic solid electrolyte is about 8:1 to 9:1.

6. The solid electrolyte material of claim 1, wherein the solid electrolyte material has an ionic conductivity of about 10⁻⁴ to 10⁻²S/cm at 25 Celsius degrees, and of about 10⁻³ to 0.1 S/cm at 100 Celsius degrees.

7. A method for preparing a solid electrolyte material of claim 1, comprising steps of:
mixing and calcining at least two components (A) and (B) to obtain the crystalline inorganic solid electrolyte; and
mixing the crystalline inorganic solid electrolyte and a component (C) to obtain the solid electrolyte material.

8. The method of claim 7, wherein an amount of the at least two components (A) and (B) and an amount of the component (C) are chosen such that a weight ratio of the crystalline inorganic solid electrolyte to the amorphous inorganic solid electrolyte is about 10:1 to 0.1:1.

9. The method of claim 8, wherein the amount of the at least two components (A) and (B) and the amount of the component (C) are chosen such that the weight ratio of the crystalline inorganic solid electrolyte to the amorphous inorganic solid electrolyte is about 8:1 to 9:1.

10. The method of claim 7, wherein the calcining step is carried out at a temperature of about 350 Celsius degrees to about 800 Celsius degrees for about 6 hours to about 100 hours.

11. The method of claim 7, wherein the crystalline inorganic solid electrolyte and the component (C) are mixed by a high energy ball-milling method at a rotation speed of about 100 rpm to about 500 rpm for about 4 hours to about 200 hours.

12. The method of claim 7, wherein the at least two components (A) and (B) respectively include a combination of Li₂S, SnS₂ and P₂S₅; a combination of Li₂O, GeO₂ and P₂O₅; a combination of Li₂O, SnO₂ and P₂O₅; a combination of Li₂S, SiS₂ and P₂S₅; a combination of Li₂S, GeS₂ and P₂S₅; a combination of Li₂S, Al₂S₃ and P₂S₅; a combination of Li₂Se, GeSe₂ and P₂Se₅; or a combination of Li₂Se, SnSe₂ and P₂Se₅.

13. The method of claim 7, wherein the component (C) includes Li₂S and P₂S₅.

14. A solid electrolyte, comprising a solid electrolyte material of claim 1.

15. A battery, comprising:
a positive electrode,
an electrolyte comprising a solid electrolyte of claim 14, and
a negative electrode.

16. The battery of claim 15, wherein the positive electrode includes the solid electrolyte of claim 14.
